(19) United States
(12) Patent Application Publication
(10) Pub. No.: US 2003/0190538 A1
(43) Pub. Date: Oct. 9, 2003

(54) Color toners and image forming method using the color toners

(75) Inventors: Shinichi Kuramoto, Numazu-shi (JP); Kanjirou Kawasaki, Numazu-shi (JP); Shohichi Sugimoto, Mishima-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: RICOH COMPANY, LTD., Tokyo (JP)

(21) Appl. No.: 10/302,898

(22) Filed: Nov. 25, 2002

Related U.S. Application Data
(63) Continuation of application No. 09/434,472, filed on Nov. 5, 1999, now abandoned.

(30) Foreign Application Priority Data
Nov. 5, 1998 (JP) 10-315029

(51) Int. Cl. G03G 9/09

(52) U.S. Cl. 430/45; 430/107.1; 430/108.23; 430/111.4; 430/109.2; 430/109.4; 430/108.21; 430/108.3; 430/124

(57) ABSTRACT

A color toner selected from the group consisting of a yellow toner, a magenta toner, and a cyan toner, and mixtures thereof, which includes a binder resin and a color pigment, wherein a C* value of a fixed red image formed by a combination of a layer of the yellow toner having a weight of 8 g/m² and a layer of the magenta toner having a weight of 8 g/m² is not less than 80, and wherein a hexagon formed by six points in a *-b* chromaticity coordinates of a fixed yellow image formed by a layer of the yellow toner having a weight of 8 g/m², the fixed red image, a fixed magenta image formed by a layer of the magenta toner having a weight of 8 g/m², a fixed blue image formed by a combination of a layer of the magenta toner having a weight of 8 g/m² and a layer of the cyan toner having a weight of 8 g/m², a fixed cyan image formed by a layer of the cyan toner having a weight of 8 g/m², and a fixed green image formed by a combination of a layer of the cyan toner of 8 g/m² and a layer of the yellow toner having a weight of 8 g/m², has an area of not less than 13600. Preferably, the yellow toner includes a benzimidazolone pigment, the cyan toner includes β copper phthalocyanine, and the magenta toner includes at least one of either Naphthol Carmine F6B or a mixture of Naphthol Carmine F6B with Naphthol Carmine FBB.

### BACKGROUND OF THE INVENTION

1. Field of the Invention

The present invention relates to color toners and an image forming method using the color toners, and more particularly to a yellow, magenta, and cyan toner which are used for forming color images using electrophotography and image forming methods using the color toners.

2. Discussion of the Background

Image forming methods using electrophotography are well known. Various color toners for use in the image forming methods have been proposed. For example, Japanese Laid-Open Patent Publication No. 9-171268 discloses color toners including a cyan toner including β phthalocyanine, a magenta toner including Rhodamine 6G xanthenesilicomolybdate, a yellow toner including a benzidine type pigment, and a black toner including carbon black. Japanese Laid-Open Patent Publication No. 9-171269 discloses color toners including a cyan toner including β phthalocyanine, a magenta toner including monoazo Lithol Rubine, a yellow toner including a benzidine type pigment, and a black toner including carbon black. These color toners can produce red images having good tint, i.e., having good color reproducibility, however the color tone of a bluish violet color image produced by them is not satisfactory.

Japanese Laid-Open Patent Publications Nos. 2-66562 and 3-107869 have disclosed quinacridone type pigments as a colorant for a magenta toner. The tint of bluish violet color images is very good, however the toners have a problem in that the color tone of a red image is not satisfactory.

In addition, a benzidine type yellow pigment, Pigment Yellow 17, is typically used for yellow toners because of having good tint and transparency, however the light resistance (in particular the resistance to sunlight) of the pigment is not good and green color images which are a combination of the yellow pigment with a cyan toner are easily changed to bluish green when the green color images are exposed to light.

Because of these reasons, a need exists for color toners which can produce color images having good color properties, in particular an excellent combination of red color reproducibility and blue color reproducibility, and good light resistance.

### SUMMARY OF THE INVENTION

Accordingly, an object of the present invention is to provide color toners which can produce color images having good color properties, in particular an excellent combination of red color reproducibility and blue color reproducibility.

Another object of the present invention is to provide color toners which can produce color images having good light resistance.

Briefly these objects and other objects of the present invention as hereinafter will become more readily apparent can be attained by a color toner selected from the group consisting of a yellow toner, a magenta toner, and a cyan toner, and mixtures thereof, which includes a binder resin and a color pigment, wherein a C* value of a fixed red image which is formed by a combination of a layer of the yellow toner having a weight of 8 g/m² and a layer of the magenta toner having a weight of 8 g/m² is not less than 80, and wherein a hexagon formed by six points in a*-b* chromaticity coordinates of a fixed yellow image formed by a layer of the yellow toner having a weight of 8 g/m², the fixed red image, a fixed magenta image formed by a layer of the magenta toner having a weight of 8 g/m², a fixed blue image formed by a combination of a layer of the magenta toner having a weight of 8 g/m² and a layer of the cyan toner having a weight of 8 g/m², a fixed cyan image formed by a layer of the cyan toner having a weight of 8 g/m², and a fixed green image formed by a combination of a layer of the cyan toner having a weight of 8 g/m² and a layer of the yellow toner having a weight of 8 g/m², has an area of not less than 13600.

In another aspect of the present invention, a color toner selected from the group consisting of a yellow toner, a magenta toner and a cyan toner, each of which includes a binder resin and a color pigment, wherein the yellow toner includes a benzimidazolone type pigment, the magenta toner includes at least one of Naphthol Carmine F6B and a mixture of Naphthol Carmine F6B with Naphthol Carmine FBB, and the cyan toner includes β copper phthalocyanine.

Each of the toners mentioned above preferably have a haze factor of not greater than 20% when each of the toners forms a layer having a weight of 8 g/m², and a melt viscosity not greater than 120 mPas·sec at 140° C.

In addition, each of the toners mentioned above preferably includes a binder resin selected from the group consisting of polyol resins, which are made by reacting (a) an epoxy resin, (b) a dihydric phenol and (C) an adduct of a dihydric phenol with alkylene oxide or its glycidyl ether compound, and polyester resins.

In yet another aspect of the present invention, a color developer is provided which includes the color toner mentioned above and a carrier.

In still another aspect of the present invention, an image forming method is provided which includes the steps of providing the color toners mentioned above; developing an electrostatic latent image with one of the toners to form a toner image; repeating the developing step using the other toners to form toner images; transferring the toner images on a receiving material to form a color image.

These and other objects, features and advantages of the present invention will become apparent upon consideration of the following description of the preferred embodiments of the present invention taken in conjunction with the accompanying drawing.

### BRIEF DESCRIPTION OF THE DRAWING

Various other objects, features and attendant advantages of the present invention will be more fully appreciated as the same becomes better understood from the detailed description when considered in connection with the accompanying drawing in which like reference characters designate like corresponding parts throughout and wherein:

FIG. 1 is a graph of a*-b* chromaticity coordinates in which hexagons are formed by the respective six points of the color images prepared in Examples 1 to 4 and Comparative Examples 1 and 2.

### DETAILED DESCRIPTION OF THE INVENTION

In color toner images, it is very important to prepare a red toner image having good brightness. The present inventors discovers that such a bright red image can be prepared by using a yellow and magenta toner such that when a combination of the yellow toner image of 8 g/m² and the magenta toner image having a weight of 8 g/m² is formed and then the formed image is fixed, the C* value of the resultant red image is not less than 80.

It is also important to prepare color images having good a color tone. The present inventors also discovers that such color images having good color tone can be prepared by using a yellow, magenta and cyan toner such that a hexagon formed by six points in a*-b* chromaticity coordinates of a fixed yellow image which is formed by a layer of the yellow toner having a weight of 8 g/m², a fixed red image which is formed by a combination of a layer of the yellow toner having a weight of 8 g/m² and a layer of the magenta toner having a weight of 8 g/m², a fixed magenta image which is formed by a layer of the magenta toner having a weight of 8 g/m², a fixed blue image which is formed by a combination of a layer of the magenta toner having a weight of 8 g/m² and a layer of the cyan toner having a weight of 8 g/m², a fixed cyan image which is formed by a layer of the cyan toner having a weight of 8 g/m², and a fixed green image which is formed by a combination of a layer of the cyan toner having a weight of 8 g/m² and a layer of the yellow toner having a weight of 8 g/m², has an area of not less than 13600.

In order to prepare such color toners, it is preferable that the toners include at least a binder resin and a pigment, and the yellow toner includes a benzimidazolone type pigment, the cyan toner includes β copper phthalocyanine, and the magenta toner includes Naphthol Carmine F6B or a combination of Naphthol Carmine F6B with Naphthol Carmine FBB. By using such toners, the resultant color images have good color reproducibility, particularly good color reproducibility of red and blue images, and good image stability, particularly good light resistance.

The values C*, a* and b* are defined in ISO 7724-1 (JIS Z8729). In the present invention, the method for measuring the values of C*, a* and b* in chromaticity coordinates is as follows:

(1) an aluminum plate having a potential is developed with a toner to form a toner layer of 8 g/m²;

(2) the toner is transferred on a transfer paper;

(3) if a mixed color image such as a red, blue and green image is formed, another toner, which is also formed on an aluminum plate, is also transferred on the transfer paper;

(4) the image is fixed with a fixing unit of a color copier, PRETER 550 manufactured by RICOH CO, LTD.;

(5) the values of C*, a* and b* of the fixed image are measured with a spectrodensitometer X-Rite 938 manufactured by X-Rite.

Next the pigments for use in the color toners of the present invention will be explained.

Specific examples of benzimidazolone pigments for use in the yellow toner of the present invention include pigments having the following formula (2):

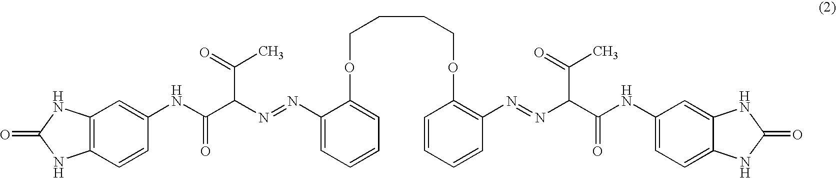

β copper Phthalocyanine for use in the cyan toner of the present invention is represented by the following formula (3):

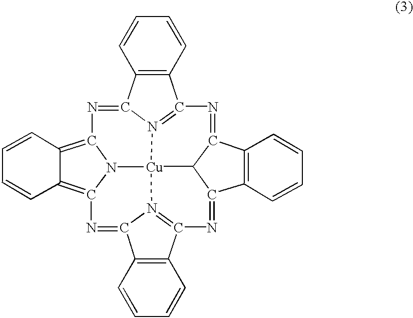

Naphthol Carmine F6B and a mixture of Naphthol Carmine F6B with Naphthol Carmine FBB for use in the magenta toner of the present invention are represented by the following formulas (4) and (5);

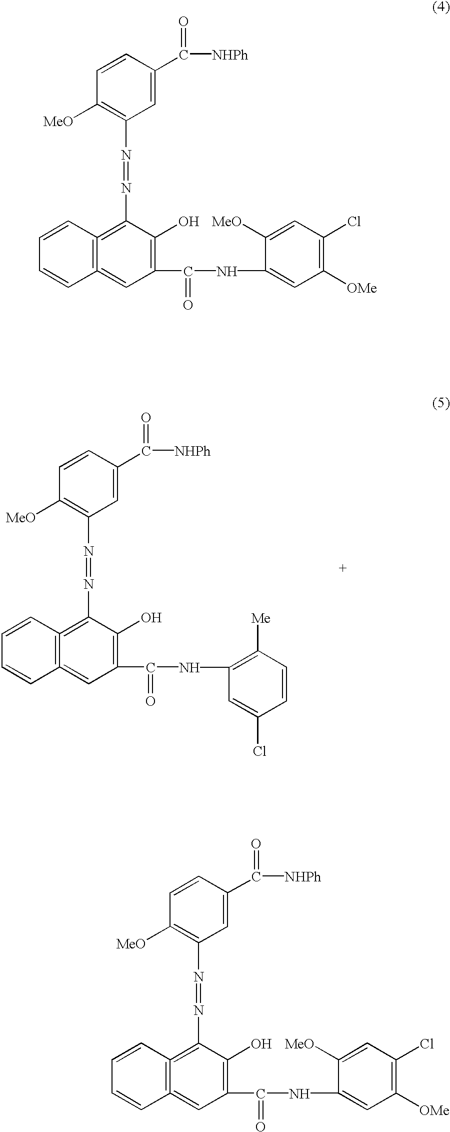

The ratio of Naphthol Carmine F6B to Naphthol Carmine FBB is preferably form 10/0 to 40/60 to maintain good color reproducibility of from a blue to violet color.

The black toner of the present invention preferably includes carbon black as a pigment.

The toners of the present invention preferably have a relatively low haze factor when the toners are processed so as to be a thin layer because the resultant toner image has good color reproducibility. Specifically, when a thin toner layer having a weight of 8 g/m² is formed, the toner layer preferably has a haze factor not greater than 20%, and more preferably not greater than 15%. The thin toner layer is formed by coating a liquid, which is prepared by dissolving the toner with tetrahydrofuran, on a PET film, and then drying the coated liquid. Haze factor can be measured by a direct-reading type Haze Computer manufactured by Suga Test Instruments Co., Ltd.

In order to prepare a toner which can produce a toner image having a relatively low haze factor, a toner manufacturing method using a master batch in which a pigment is dispersed in a binder resin in a high content is preferably used. In order to prepare a master batch of a toner, flashing methods in which an aqueous cake including a pigment is mixed with a resin in a flasher, and kneading methods in which a pigment is kneaded with a resin using a two-roll or three-roll mill can be preferably used.

In order to obtain color images having good reproducibility, it is important that each of the color toners melts and uniformly mixes with each other when fixed. This mixing is largely affected by the melt viscosity of the toners. The melt viscosity of the toners of the present invention is preferably not greater than 120 mpas·sec at 140° C. In the present invention, the melt viscosity is measured by a constant temperature method using a flow tester model CFT-500 manufactured by Shimazu Corp., under conditions that the diameter of a dice used is 1 mm, and the pressure is 20 Kg/cm².

In the present invention, materials for use in the toners other than the pigments include known materials.

Specific examples of the binder resins for use in the toners include styrene polymers and substituted styrene polymers such as polystyrene, poly-p-chlorostyrene, polyvinyltoluene and the like; styrene copolymers such as styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinylmethylketone copolymers, styrene-butadiene copolymers, styrene-isoprene copolymers, styrene-acrylonitrile-indene copolymers, styrene-maleic acid copolymers, styrene-maleic acid ester copolymers and the like; and other resins such as polymethyl methacrylate, polybutyl methacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosin, terpene resins, aliphatic or alicyclic hydrocarbon resins, aromatic petroleum resins and the like. These resins are used alone or in combination.

In order to prepare toners having good color reproducibility, the toners preferably include as a binder resin a polyol resin which includes a polyoxyalkylene chain as a main chain and which is prepared by reacting at least (a) an epoxy resin, (b) a dihydric phenol compound and (c) an adduct of a dihydric phenol compound with an alkylene oxide or its glycidyl ether compound.

Specific examples of the epoxy resin for use in the polyol resin include epoxy resins which are prepared by reacting a bisphenol compound such as bisphenol A and bisphenol F with epichlorohydrin. Specific examples of the dihydric phenol compound include bisphenol A, bisphenol F and the like. Specific examples of the adducts of a dihydric phenol compound with an alkylene oxide include reaction products of ethylene oxide, propylene oxide, butylene oxide or a mixture thereof with a bisphenol compound such as bisphenol A or bisphenol F. The reaction products may be further reacted with epichlorohydrin or β-methylepichlorohydrin to prepare a glycidyl ether compound thereof. In addition, a monohydric phenol compound such as phenol, cresol, isopropyl phenol, aminophenol, octyl phenol, nonyl phenol, dodecyl phenol, p-cumyl phenol and the like may be reacted therewith.

The softening point of the polyol resins for use in the present invention is preferably from 115 to 130° C. When the softening point is less than 115° C., a problem which tend to occur is that aggregates of the toner are formed in a toner bottle or a developing unit, resulting in occurrence of white streak images or white spot images in developed images. In contrast, when the softening point is greater than 130° C., images having high gloss tend not to be obtained.

In the present invention, polyester resins are also preferably used as a binder resin. The acid value of the polyester resins for use in the present invention is from 5 to 60, and more preferably from 10 to 20. When the acid value is too low, good images tend not to be obtained when a one-component developer is used, or a small size developing unit, which contains a small amount of two-component full color developers, is used. In contrast, when the acid value is too large, the stability of the resultant toners tends to deteriorate, and particularly the charge stability in high humidity conditions tends to deteriorate.

The softening point of the polyester resins is preferably from 115 to 130° C. When the softening point is less than 115° C., a problem which occurs is that the resultant toner tend to aggregate in a toner bottle or a developing unit, resulting in occurrence of white streak images or white spot images in developed images. In contrast, when the softening point is greater than 130° C., images having high gloss tend not to be obtained.

The polyester resins for use in the present invention include polyester resins which are prepared by condensation polymerizing a compound having two or more carboxyl groups and a compound having two or more hydroxy groups. In the present invention, adducts of a dihydric phenol compound with an alkylene oxide are preferably used as the compound having two or more hydroxy groups. Specific examples of the adducts include adducts of a dihydric phenol compound such as bisphenol A, bisphenol F, bisphenol S or the like with an alkylene oxide such as ethylene oxide, propylene oxide, butylene oxide or the like. Among these adducts, adducts of bisphenol A with ethylene oxide or propylene oxide of from 2 to 8 moles are preferable.

Other dihydric alcohols can also be used as the compound having two or more hydroxy groups. Specific examples of such dihydric alcohols include alkylene glycols such as ethylene glycol, 1,2-propylen glycol, 1,3-propylen glycol, 1,4-butane diol, neopentyl glycol, 1,4-butene diol, 1,5-pentane diol, 1,6-hexane diol and the like; alkylene ether glycols such as diethylene glycol, triethylene glycol, dipropylene glycol, polyethylene glycol, polypropylene glycol, polytetramethylene glycol and the like; alicyclic diols such as 1,4-cyclohexanedimethanol, hydrogenated bisphenol A and the like; bisphenols such as bisphenol A, bisphenol F, bisphenol S and the like; and the like.

Specific examples of the compounds having two carboxyl groups include aliphatic dicarboxylic acids and their derivatives such as maleic acid, fumaric acid, succinic acid, adipic acid, sebacic acid, malonic acid, azelaic acid, mesaconic acid, citraconic acid, glutaconic acid, octylsuccinic acid, decylsuccinic acid, tetradecylsuccinic acid, hexadecylsuccinic acid, octadecylsuccinic acid, isooctadecylsuccinic acid, hexenylsuccinic acid, octenylsuccinic acid, decenylsuccinic acid, dodecenylsuccinic acid, tetrapropenylsuccinic acid, tetradecenylsuccinic acid, hexadecenylsuccinic acid, isooctadecenylsuccinic acid, octadecenylsuccinic acid, nonenylsuccinic acid and the like; alicyclic dicarboxylic acids such as cyclohexanedicarboxylic acid, and the like; aromatic dicarboxylic acids such as phthalic acid, isophthalic acid, terephthalic acid, toluenedicarboxylic acid, naphthalenedicarboxylic acid and the like; and anhydrides of these dicarboxylic acids and low alkyl (methyl, butyl and the like) esters of these dicarboxylic acids.

Among these dicarboxylic acids, terephthalic acid and isophthalic acid are preferable because terephthalic acid can increase glass transition temperature of the resultant polyester resins and isophthalic acid has good reactivity.

In the present invention, carboxylic acids having tree or more carboxyl groups can also be used as the compounds having two or more carboxylic groups. Specific examples thereof include trimellitic acid, pyromellitic acid, 1,2,4-cyclohexanetricarboxylic acid, 2,5,7-naphthalenetricarboxylic acid, 1,2,4-naphthalenetricarboxylic acid, 1,2,5-hexanetricarboxylic acid, 1,2,7,8-octanetetracarboxylic acid, and anhydrides thereof.

Polyhydric alcohols having three or more hydroxy groups can also be used. Specific examples thereof include sorbitol, 1,2,3,6-hexanetetraol, 1,4-sorbitane, pentaerythritol, dipentaerythritol, tripentaerythritol, saccharose, 1,2,4-butanetriol, 1,2,5-pentatriol, glycerol, 2-methylpropanetriol, 2-methyl-1,2,4-butanetriol, trimethylolethane, trimethylolpropane, 1,3,5-trihydroxymethylbenzene and the like.

These acids and alcohols can be used alone or in combination.

The toners of the present invention may include a charge controlling agent. Specific examples of the charge controlling agent include known charge controlling agents such as Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, activators including fluorine, and the like. In the present invention, aromatic hydroxycarboxylic acid derivatives including a metal such as zinc, chromium, cobalt, aluminum, iron, zirconium and the like are preferably used as the charge controlling agent. Among these aromatic hydroxycarboxylic acid derivatives, compounds having the following formula (1) are more preferable.

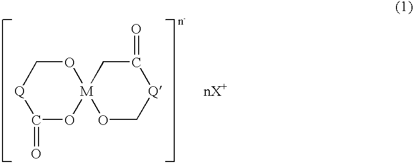

wherein Q and Q′ independently represent an aromatic oxycarboxylic acid group which optionally-substituted with an alkyl and/or an aralkyl group; X represents a counter ion; and M represents a metal.

Among these aromatic hydroxycarboxylic acid derivatives, zinc salts of aromatic hydroxycarboxylic acid derivatives are most preferable because the resultant toners have good color reproducibility and good charge properties.

Specific examples of the zinc salts of aromatic hydroxycarboxylic acid derivatives are shown in Tables 1 to 9.

TABLE 1

| | |
|---|---|
| 1. | 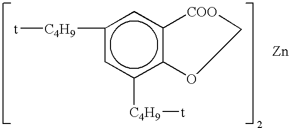 |
| 2. | 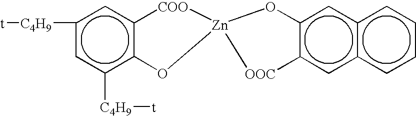 |
| 3. | 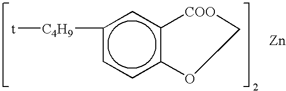 |
| 4. | 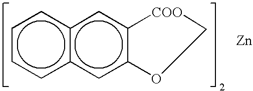 |
| 5. | 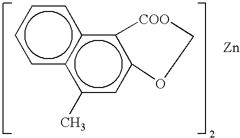 |
| 6. | 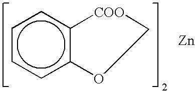 |

TABLE 2

| | |
|---|---|
| 7. | 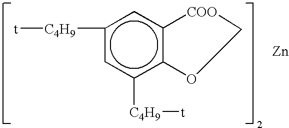 |
| 8. | 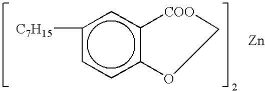 |
| 9. | 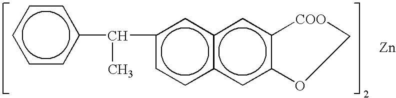 |
| 10. | 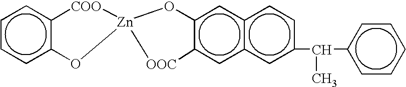 |
| 11. | 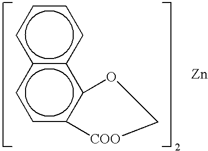 |
| 12. | 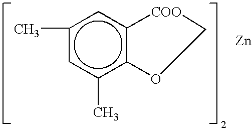 |

TABLE 3

| | |
|---|---|
| 13. | 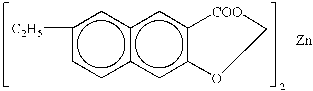 |
| 14. | 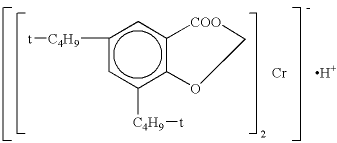 |
| 15. | 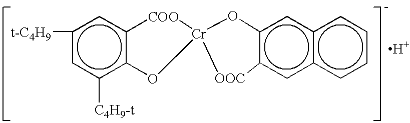 |
| 16. | 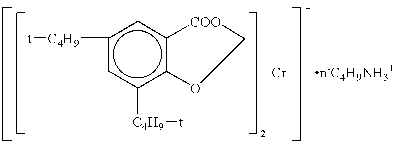 |
| 17. | 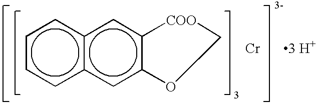 |
| 18. | 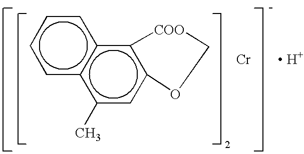 |

TABLE 4

| | |
|---|---|
| 19. | 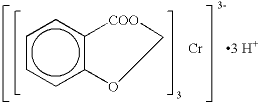 |
| 20. | 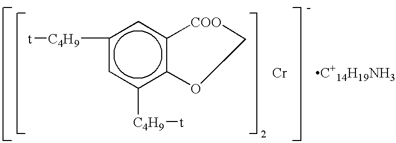 |
| 21. | 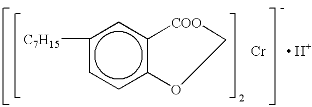 |
| 22. | 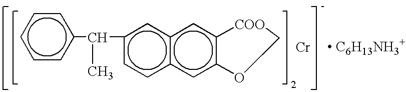 |
| 23. | 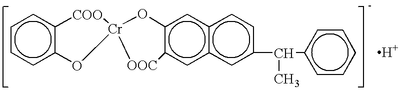 |
| 24. | 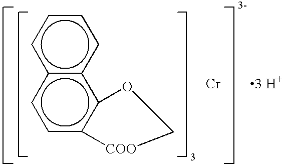 |

TABLE 5

| | |
|---|---|
| 25. | 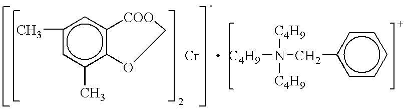 |
| 26. | 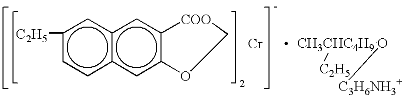 |
| 27. | 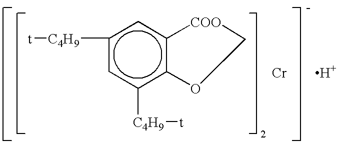 |
| 28. | 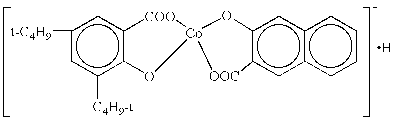 |
| 29. | 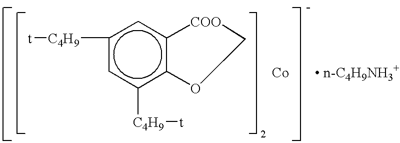 |
| 30. | 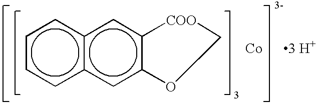 |

TABLE 6

| | |
|---|---|
| 31. | 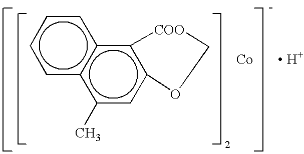 |
| 32. | 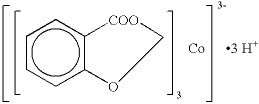 |
| 33. | 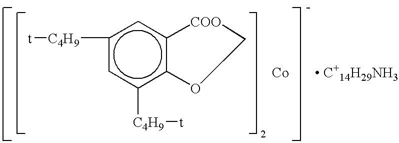 |
| 34. | 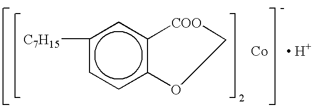 |
| 35. | 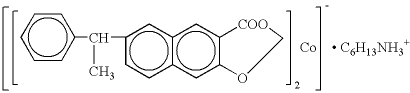 |
| 36. | 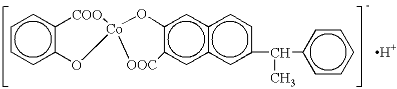 |

TABLE 7

| | |
|---|---|
| 37. | 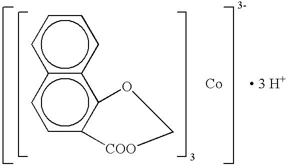 |
| 38. | 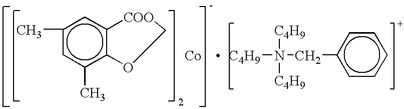 |
| 39. | 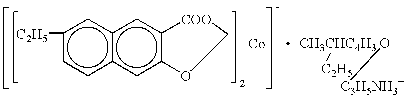 |
| 40. | 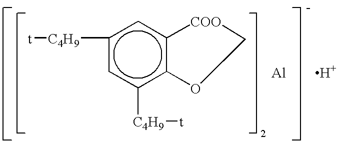 |
| 41. | 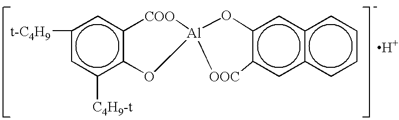 |
| 42. | 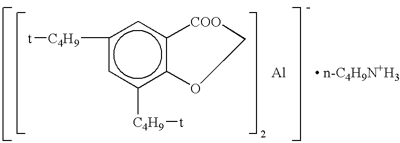 |

TABLE 8

| | |
|---|---|
| 43. | 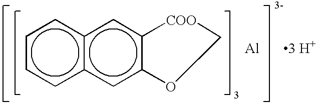 |
| 44. | 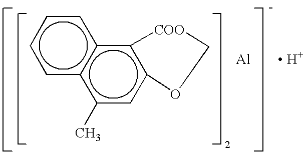 |
| 45. | 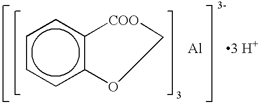 |
| 46. | 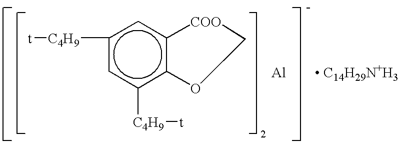 |
| 47. | 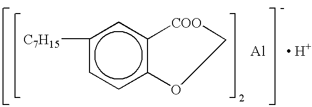 |
| 48. | 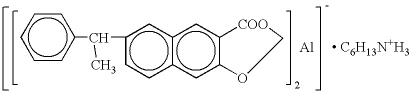 |

TABLE 9

| | |
|---|---|
| 49. | 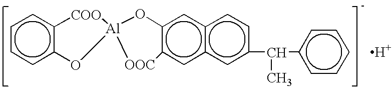 |
| 50. | 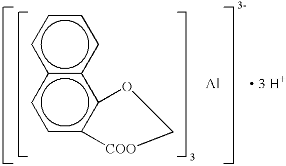 |
| 51. | 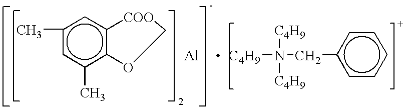 |
| 52. | 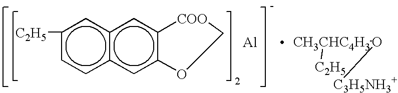 |

Compounds which are prepared by reacting an aromatic oxycarboxylic acid or it salt with a zirconium compound can also be preferably used as the charge controlling agent. Specific examples of the compounds are disclosed in International Application WO99/12941. For example, compounds having the following formula are exemplified:

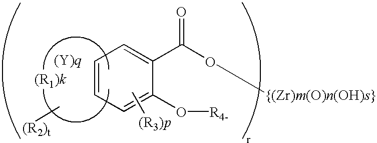

wherein R1 represents a quarternary carbon atom, a methine group, and a methylene group, and may include a hetero atom such as a nitrogen atom, a sulfur atom, an oxygen atom and a phosphor atom; Y represents a saturated or unsaturated cyclic group; R2 and R3 independently represent an alkyl group, an alkenyl group, an alkoxy group, an aryl group which may be substituted, an aryloxy group which may be substituted, an aralkyl group which may be substituted, an aralkyloxy group which may be substituted, a halogen atom, a hydrogen atom, a hydroxy group, an amino group which may be substituted, a carboxyl group, a nitro group, a nitroso group, a sulfonyl group, and a cyano group; R4 represents a hydrogen atom and an alkyl group; k is 0 or an integer of from 3 to 12; m is an integer of from 1 to 20; n is 0 or an integer of from 1 to 20; p is 0 or an integer of from 1 to 4; q is 0 or an integer of from 1 to 3; r is an integer of from 1 to 20; s is 0 or an integer of from 1 to 20; and t is 0 or an integer of from 1 to 4.

In the present invention, the content of the charge controlling agent in a toner is determined depending on species of the binder resin used, whether or not other additives are added thereto, and the manufacturing method used.

Preferably, the content of the charge controlling agent is from 0.1 to 10 parts by weight, and more preferably from 2 to 5 parts by weight, per 100 parts by weight of the binder resin.

When the content of the charge controlling agent is less than 0.1 parts, the charge quantity of the resultant toner is poor. In contrast, when the content is greater than 10 parts, the charge quantity of the resultant toner is too large, resulting in decrease of fluidity of the toner and image quality of the resultant toner images.

Charge controlling agents can be used alone or in combination.

The toners of the present invention may include other additives. Specific examples of such additives include colloidal silica, hydrophobic silica, metal salts of fatty acids such as zinc stearate, aluminum stearate and the like; metal oxides such as titanium oxide, aluminum oxide, tin oxide, antimony oxide and the like; fluorine containing polymers and the like. Among these additives, hydrophobic silica, hydrophobic titania and hydrophobic alumina are preferable.

Specific examples of the hydrophobic silica include HDK H 2000, HDK H 2000/4, HDK H 2050EP, and HVK21, which are manufactured by Clariant; and R972, R974, RX200, RY200, R202, R805, and R812, which are manufactured by Nippon Aerosil Co.

Specific examples of the titania include P-25 which is manufactured by Nippon Aerosil Co.; STT-30, and STT-65C—S, which are manufactured by Titan Kogyo K.K.; TAF-140, which is manufactured by Fuji Titan Industry Co., Ltd.; and MT-150W, MT-500B, and MT-600B, which are manufactured by Tayca Corp. Specific examples of the titanium oxides, which are subjected to a hydrophobic treatment, include T-805, which is manufactured by Nippon Aerosil Co.; STT-30A, and STT-65S—S, which are manufactured by Titan Kogyo K.K.; TAF-500T and TAF-1500T, which are manufactured by Fuji Titan Industry Co., Ltd.; MT-100S and MT-100T, which are manufactured by Tayca Corp.; and IT-S, which is manufactured by Ishihara Sangyo Kaisha Ltd.

Hydrophobic silica, titania and alumina can also be prepared by treating hydrophilic silica, titania and alumina with a silane coupling agent such as methyltrimethoxy silane, methyltriethoxy silane, octyltrimethoxy silane and the like, or a silicone oil.

The toner of the present invention can be used for developing method using a one-component developer, in which a toner serving as a one-component developer is used for developing electrostatic latent images, and developing methods using a two-component developer, in which a mixture of a toner and a carrier, which serve as a two-component developer, is used for developing electrostatic latent images.

Carriers for use in combination with the toners of the present invention in two-component developers include known carrier materials such as iron powders, ferrite powder, glass beads and the like. These carriers may be coated with a resin such as polyfluorocarbons, polyvinyl chloride, polyvinylidene chloride, phenolic resins, polyvinyl acetal resins, silicone resins and the like.

In the present invention, the mixing ratio of the toner to the carrier in two-component developers is 0.5/100 to 10/100 by weight.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Toner Manufacturing Example 1

Black Toner 1

The following components were mixed with a flasher.

| | |
|---|---|
| Water | 1200 |
| Phthalocyanine aqueous cake | 200 |
| (solid content of 30%) | |
| Carbon black | 540 |

(MA60, manufactured by Mitsubishi Chemical Corp.)

One thousand and two hundred (1200) parts of a polyester resin (acid value of 3, hydroxy value of 25, number average molecular weight Mn of 45000, Mw/Mn of 4.0 and transition temperature of 60° C.) were added to the mixture, and the mixture was kneaded at 150° C. for 30 minutes. After kneading, 1000 parts of xylene were added to the kneaded mixture, and the mixture was further kneaded for 1 hour. Water and xylene were then removed therefrom, and the mixture was cooled by rolling and pulverized with a pulverizer. Thus, a master batch pigment was prepared.

The following components were mixed, and then melted and kneaded with a two-roll mill.

| | |
|---|---|
| Polyester resin | 100 |
| (acid value of 3, hydroxy value of 25, number average | |
| molecular weight Mn of 45000, Mw/Mn of 4.0 and transition | |
| temperature of 60° C.) | |
| Master batch pigment prepared above | 5 |
| Compound having formula 1-1 | 4 |

(Charge Controlling Agent)

The kneaded mixture was cooled by rolling, and then pulverized and classified. Thus, mother particles of a black toner having a volume average particle diameter of 7.5 μm were prepared. In addition, a hydrophobic silica (H2000, manufactured by Clariant Japan.) was added thereto in an amount of 0.5% by weight, and then the mixture was mixed with a mixer to prepare a black toner 1. The haze factor of a thin layer of black toner 1 having a weight of 8 g/m² was 16%, and the melt viscosity of the toner was 96 mPas·sec at 140° C.

Yellow Toner 1

The following components were mixed with a flasher.

| | |
|---|---|
| Water | 600 |
| Aqueous cake of pigment having formula (2) | 1200 |

(solid content of 50%)

One thousand and two hundred (1200) parts of a polyester resin (acid value of 3, hydroxy value of 25, number average molecular weight Mn of 45000, Mw/Mn of 4.0 and transition temperature of 60° C.) were added to the mixture, and the mixture was kneaded at 150° C. for 30 minutes. After kneading, 1000 parts of xylene were added to the kneaded mixture, and the mixture was further kneaded for 1 hour. Water and xylene were then removed therefrom, and the mixture was cooled by rolling and pulverized with a pulverizer. In addition, the mixture was passed through a three-roll mill twice. Thus, a master batch pigment was prepared.

The following components were mixed, and then melted and kneaded with a two-roll mill.

| | |
|---|---|
| Polyester resin | 100 |
| (acid value of 3, hydroxy value of 25, number average | |
| molecular weight Mn of 45000, Mw/Mn of 4.0 and transition | |
| temperature of 60° C.) | |
| Master batch pigment prepared above | 5 |
| Compound having formula 1-1 | 4 |

(Charge Controlling Agent)

The kneaded mixture was cooled by rolling, and then pulverized and classified. Thus, mother particles of a yellow toner having a volume average particle diameter of 10 μm were prepared. In addition, a hydrophobic silica (H2000, manufactured by Clariant Japan.) was added thereto in an amount of 0.5% by weight, and then the mixture was mixed with a mixer to prepare a yellow toner 1. The haze factor of a thin layer of yellow toner 1 having a weight of 8 g/m² was 17%, and the melt viscosity of the toner was 98 mPas·sec at 140° C.

Magenta Toner 1

The following components were mixed with a flasher.

| | |
|---|---|
| Water | 600 |
| Aqueous cake of pigment having formula (4) | 1200 |

(solid content of 50%)

One thousand and two hundred (1200) parts of a polyester resin (acid value of 3, hydroxy value of 25, number average molecular weight Mn of 45000, Mw/Mn of 4.0 and transition temperature of 60° C.) were added to the mixture, and the mixture was kneaded at 150° C. for 30 minutes. After kneading, 1000 parts of xylene were added to the kneaded mixture, and the mixture was further kneaded for 1 hour. Water and xylene were then removed therefrom, and the mixture was cooled by rolling and pulverized with a pulverizer. In addition, the mixture was passed through a three-roll mill twice. Thus, a master batch pigment was prepared.

The following components were mixed, and then melted and kneaded with a two-roll mill.

| | |
|---|---|
| Polyester resin | 100 |
| (acid value of 3, hydroxy value of 25, number average | |
| molecular weight Mn of 45000, Mw/Mn of 4.0 and transition | |
| temperature of 60° C.) | |
| Master batch pigment prepared above | 5 |
| Compound having formula 1-1 | 4 |

(Charge Controlling Agent)

The kneaded mixture was cooled by rolling, and then pulverized and classified. Thus, mother particles of a magenta toner having a volume average particle diameter of 10 μm were prepared. In addition, a hydrophobic silica (H2000, manufactured by Clariant Japan.) was added thereto in an amount of 0.5% by weight, and then the mixture was mixed with a mixer to prepare a magenta toner 1. The haze factor of a thin layer of magenta toner 1 having a weight of 8 g/m² was 18%, and the melt viscosity of the toner was 17 mPas·sec at 140° C.

Cyan Toner 1

The following components were mixed with a flasher.

| | |
|---|---|
| Water | 600 |
| Aqueous cake of pigment having formula (3) | 1200 |

(solid content of 50%)

One thousand and two hundred (1200) parts of a polyester resin (acid value of 3, hydroxy value of 25, number average molecular weight Mn of 45000, Mw/Mn of 4.0 and transition temperature of 60° C.) were added to the mixture, and the mixture was kneaded at 150° C. for 30 minutes. After kneading, 1000 parts of xylene were added to the kneaded mixture, and the mixture was further kneaded for 1 hour. Water and xylene were then removed therefrom, and the mixture was cooled by rolling and pulverized with a pulverizer. In addition, the mixture was passed through a three-roll mill twice. Thus, a master batch pigment was prepared.

The following components were mixed, and then melted and kneaded with a two-roll mill.

| | |
|---|---|
| Polyester resin | 100 |
| (acid value of 3, hydroxy value of 25, number average | |
| molecular weight Mn of 45000, Mw/Mn of 4.0 and transition | |
| temperature of 60° C.) | |
| Master batch pigment prepared above | 3 |
| Compound having formula 1-1 | 4 |

(Charge Controlling Agent)

The kneaded mixture was cooled by rolling, and then pulverized and classified. Thus, mother particles of a cyan toner having a volume average particle diameter of 10 μm were prepared. In addition, a hydrophobic silica (H2000, manufactured by Clariant Japan.) was added thereto in an amount of 0.5% by weight, and then the mixture was mixed with a mixer to prepare a cyan toner 1. The haze factor of a thin layer of cyan toner 1 having a weight of 8 g/m² was 15%, and the melt viscosity of the toner was 34 mPas·sec at 140° C.

### Toner Manufacturing Example 2

Black Toner 2

The following components were mixed with a mixer, and then kneaded 5 times with a three-roll mill.

| | |
|---|---|
| Carbon black | 800 |
| (MA60, manufactured by Mitsubishi Chemical Corp.) | |
| Polyol resin | 1200 |
| (number average molecular weight of 3800, Mw/Mn of 4.2, and | |
| transition temperature of 60° C.) | |

The mixture was cooled by rolling, and then pulverized with a pulverizer. Thus, a master batch pigment was prepared.

The following components were mixed, and then melted and kneaded with a two-roll mill.

| | |
|---|---|
| Polyol resin | 100 |
| (number average molecular weight Mn of 3800, Mw/Mn of 4.2 | |
| and transition temperature of 60° C.) | |
| Master batch pigment prepared above | 6 |
| Compound having formula 1-20 | 3 |

(Charge Controlling Agent)

The kneaded mixture was cooled by rolling, and then pulverized and classified. Thus, mother particles of a black toner having a volume average particle diameter of 7.5 μm were prepared. In addition, a hydrophobic silica (H2000, manufactured by Clariant Japan.) was added thereto in an amount of 0.5% by weight, and then the mixture was mixed with a mixer to prepare a black toner 2. The haze factor of a thin layer of black toner 2 having a weight of 8 g/m² was 14%, and the melt viscosity of the toner was 88 mPas·sec at 140° C.

Yellow Toner 2

The following components were mixed with a mixer, and then kneaded 5 times with a three-roll mill.

| | |
|---|---|
| Pigment having formula (2) | 800 |
| Polyol resin | 1200 |
| (number average molecular weight of 3800, Mw/Mn of 4.2, and | |
| transition temperature of 60° C.) | |

The mixture was cooled by rolling, and then pulverized with a pulverizer. Thus, a master batch pigment was prepared.

The following components were mixed, and then melted and kneaded with a two-roll mill.

| | |
|---|---|
| Polyol resin | 100 |
| (number average molecular weight Mn of 3800, Mw/Mn of 4.2 | |
| and transition temperature of 60° C.) | |
| Master batch pigment prepared above | 6 |
| Compound having formula 1-20 | 3 |

(Charge Controlling Agent)

The kneaded mixture was cooled by rolling, and then pulverized and classified. Thus, mother particles of a yellow toner having a volume average particle diameter of 10 μm were prepared. In addition, a hydrophobic silica (H2000, manufactured by Clariant Japan.) was added thereto in an amount of 0.5% by weight, and then the mixture was mixed with a mixer to prepare a yellow toner 2. The haze factor of a thin layer of yellow toner 2 having a weight of 8 g/m² was 15%, and the melt viscosity of the toner was 91 mPas·sec at 140° C.

Magenta Toner 2

The following components were mixed with a mixer, and then kneaded 5 times with a three-roll mill.

| | |
|---|---|
| Pigment having formula (4) | 400 |
| Pigment having formula (5) | 400 |
| Polyol resin | 1200 |
| (number average molecular weight of 3800, Mw/Mn of 4.2, and | |
| transition temperature of 60° C.) | |

The mixture was cooled by rolling, and then pulverized with a pulverizer. Thus, a master batch pigment was prepared.

The following components were mixed, and then melted and kneaded with a two-roll mill.

| | |
|---|---|
| Polyol resin | 100 |
| (number average molecular weight Mn of 3800, Mw/Mn of 4.2 | |
| and transition temperature of 60° C.) | |
| Master batch pigment prepared above | 6 |
| Compound having formula 1-20 | 3 |

(Charge Controlling Agent)

The kneaded mixture was cooled by rolling, and then pulverized and classified. Thus, mother particles of a magenta toner having a volume average particle diameter of 10 μm were prepared. In addition, a hydrophobic silica (H2000, manufactured by Clariant Japan.) was added thereto in an amount of 0.5% by weight, and then the mixture was mixed with a mixer to prepare a magenta toner 2. The haze factor of a thin layer of magenta toner 2 having a weight of 8 g/m² was 14%, and the melt viscosity of the toner was 86 mPas·sec at 140° C.

Cyan Toner 2

The following components were mixed with a mixer, and then kneaded 5 times with a three-roll mill.

| | |
|---|---|
| Pigment having formula (3) | 800 |
| Polyol resin | 1200 |
| (number average molecular weight of 3800, Mw/Mn of 4.2, and | |
| transition temperature of 60° C.) | |

The mixture was cooled by rolling, and then pulverized with a pulverizer. Thus, a master batch pigment was prepared.

The following components were mixed, and then melted and kneaded with a two-roll mill.

| | |
|---|---|
| Polyol resin | 100 |
| (number average molecular weight Mn of 3800, Mw/Mn of 4.2 | |
| and transition temperature of 60° C.) | |
| Master batch pigment prepared above | 5 |
| Compound having formula 1-20 | 4 |

(Charge Controlling Agent)

The kneaded mixture was cooled by rolling, and then pulverized and classified. Thus, mother particles of a cyan toner having a volume average particle diameter of 10 μm were prepared. In addition, a hydrophobic silica (H2000, manufactured by Clariant Japan.) was added thereto in an amount of 0.5% by weight, and then the mixture was mixed with a mixer to prepare a cyan toner 2. The haze factor of a thin layer of cyan toner 2 having a weight of 8 g/m² was 12%, and the melt viscosity of the toner was 87 mPas·sec at 140° C.

### Toner Manufacturing Example 3

Black Toner 3

The following components were mixed with a mixer, and then kneaded 5 times with a three-roll mill.

| | |
|---|---|
| Carbon black | 800 |
| (MA60, manufactured by Mitsubishi Chemical Corp.) | |
| Polyol resin | 1200 |
| (number average molecular weight of 5600, Mw/Mn of 5.8, and | |
| transition temperature of 63° C.) | |

The mixture was cooled by rolling, and then pulverized with a pulverizer. Thus, a master batch pigment was prepared.

The following components were mixed, and then melted and kneaded with a two-roll mill.

| | |
|---|---|
| Polyol resin | 100 |
| (number average molecular weight Mn of 5600, Mw/Mn of 5.8 | |
| and transition temperature of 63° C.) | |
| Master batch pigment prepared above | 6 |
| Compound having formula 1-20 | 3 |
| (Charge controlling agent) | |

The kneaded mixture was cooled by rolling, and then pulverized and classified. Thus, mother particles of a black toner having a volume average particle diameter of 7.5 μm were prepared. In addition, a hydrophobic silica (H2000, manufactured by Clariant Japan.) was added thereto in an amount of 0.5% by weight, and then the mixture was mixed with a mixer to prepare a black toner 3. The haze factor of a thin layer of black toner 2 having a weight of 8 g/m² was 19%, and the melt viscosity of the toner was 125 mPas·sec at 140° C.

Yellow Toner 3

The following components were mixed with a mixer, and then kneaded 5 times with a three-roll mill.

| | |
|---|---|
| Pigment having formula (2) | 800 |
| Polyol resin | 1200 |
| (number average molecular weight of 5600, Mw/Mn of 5.8, and | |
| transition temperature of 63° C.) | |

The mixture was cooled by rolling, and then pulverized with a pulverizer. Thus, a master batch pigment was prepared.

The following components were mixed, and then melted and kneaded with a two-roll mill.

| | |
|---|---|
| Polyol resin | 100 |
| (number average molecular weight Mn of 5600, Mw/Mn of 5.8 | |
| and transition temperature of 63° C.) | |
| Master batch pigment prepared above | 6 |
| Compound having formula 1-20 | 3 |

(Charge Controlling Agent)

The kneaded mixture was cooled by rolling, and then pulverized and classified. Thus, mother particles of a yellow toner having a volume average particle diameter of 10 μm were prepared. In addition, a hydrophobic silica (H2000, manufactured by Clariant Japan.) was added thereto in an amount of 0.5% by weight, and then the mixture was mixed with a mixer to prepare a yellow toner 3. The haze factor of a thin layer of yellow toner 3 having a weight of 8 g/m² was 19%, and the melt viscosity of the toner was 121 mPas·sec at 140° C.

Magenta Toner 3

The following components were mixed with a mixer, and then kneaded 5 times with a three-roll mill.

| | |
|---|---|
| Pigment having formula (4) | 400 |
| Pigment having formula (5) | 400 |
| Polyol resin | 1200 |
| (number average molecular weight of 5600, Mw/Mn of 5.8, and | |
| transition temperature of 63° C.) | |

The mixture was cooled by rolling, and then pulverized with a pulverizer. Thus, a master batch pigment was prepared.

The following components were mixed, and then melted and kneaded with a two-roll mill.

| | |
|---|---|
| Polyol resin | 100 |
| (number average molecular weight Mn of 5600, Mw/Mn of 5.8 | |
| and transition temperature of 63° C.) | |
| Master batch pigment prepared above | 6 |
| Compound having formula 1-20 | 3 |

(Charge Controlling Agent)

The kneaded mixture was cooled by rolling, and then pulverized and classified. Thus, mother particles of a magenta toner having a volume average particle diameter of 10 μm were prepared. In addition, a hydrophobic silica (H2000, manufactured by Clariant Japan.) was added thereto in an amount of 0.5% by weight, and then the mixture was mixed with a mixer to prepare a magenta toner 3. The haze factor of a thin layer of magenta toner 3 having a weight of 8 g/m² was 18%, and the melt viscosity of the toner was 123 mPas·sec at 140° C.

Cyan Toner 3

The following components were mixed with a mixer, and then kneaded 5 times with a three-roll mill.

| | |
|---|---|
| Pigment having formula (3) | 800 |
| Polyol resin | 1200 |
| (number average molecular weight of 5600, Mw/Mn of 5.8, and | |
| transition temperature of 63° C.) | |

The mixture was cooled by rolling, and then pulverized with a pulverizer. Thus, a master batch pigment was prepared.

The following components were mixed, and then melted and kneaded with a two-roll mill.

| | |
|---|---|
| Polyol resin | 100 |
| (number average molecular weight Mn of 3800, Mw/Mn of 4.2 | |
| and transition temperature of 60° C.) | |
| Master batch pigment prepared above | 5 |
| Compound having formula 1-20 | 4 |

(Charge Controlling Agent)

The kneaded mixture was cooled by rolling, and then pulverized and classified. Thus, mother particles of a cyan toner having a volume average particle diameter of 10 μm were prepared. In addition, a hydrophobic silica (H2000, manufactured by Clariant Japan.) was added thereto in an amount of 0.5% by weight, and then the mixture was mixed with a mixer to prepare a cyan toner 3. The haze factor of a thin layer of cyan toner 3 having a weight of 8 g/m² was 16%, and the melt viscosity of the toner was 122 mPas·sec at 140° C.

### Toner Manufacturing Example 4

Black Toner 4

The following components were mixed with a mixer, and then kneaded with a three-roll mill such that the mixture was passed through the three-roll mill twice.

| | |
|---|---|
| Carbon black | 800 |
| (MA60, manufactured by Mitsubishi Chemical Corp.) | |
| Polyol resin | 1200 |
| (number average molecular weight of 3800, Mw/Mn of 4.2, and | |
| transition temperature of 60° C.) | |

The mixture was cooled by rolling, and then pulverized with a pulverizer. Thus, a master batch pigment was prepared.

The following components were mixed, and then melted and kneaded with a two-roll mill.

| | |
|---|---|
| Polyol resin | 100 |
| (number average molecular weight Mn of 3800, Mw/Mn of 4.2 | |
| and transition temperature of 60° C.) | |
| Master batch pigment prepared above | 6 |
| Compound having formula 1-20 | 3 |

(Charge Controlling Agent)

The kneaded mixture was cooled by rolling, and then pulverized and classified. Thus, mother particles of a black toner having a volume average particle diameter of 7.5 μm were prepared. In addition, a hydrophobic silica (H2000, manufactured by Clariant Japan.) was added thereto in an amount of 0.5% by weight, and then the mixture was mixed with a mixer to prepare a black toner 4. The haze factor of a thin layer of black toner 4 having a weight of 8 g/m² was 21%, and the melt viscosity of the toner was 88 mPas·sec at 140° C.

Yellow Toner 4

The following components were mixed with a mixer, and then kneaded with a three-roll mill such that the mixture was passed through the three-roll mill twice.

| | |
|---|---|
| Pigment having formula (2) | 800 |
| Polyol resin | 1200 |
| (number average molecular weight of 3800, Mw/Mn of 4.2, and | |
| transition temperature of 60° C.) | |

The mixture was cooled by rolling, and then pulverized with a pulverizer. Thus, a master batch pigment was prepared.

The following components were mixed, and then melted and kneaded with a two-roll mill.

| | |
|---|---|
| Polyol resin | 100 |
| (number average molecular weight Mn of 3800, Mw/Mn of 4.2 | |
| and transition temperature of 60° C.) | |
| Master batch pigment prepared above | 6 |
| Compound having formula 1-20 | 3 |

(Charge Controlling Agent)

The kneaded mixture was cooled by rolling, and then pulverized and classified. Thus, mother particles of a yellow toner having a volume average particle diameter of 10 μm were prepared. In addition, a hydrophobic silica (H2000, manufactured by Clariant Japan.) was added thereto in an amount of 0.5% by weight, and then the mixture was mixed with a mixer to prepare a yellow toner 4. The haze factor of a thin layer of yellow toner 4 having a weight of 8 g/m² was 23%, and the melt viscosity of the toner was 91 mPas·sec at 140° C.

Magenta Toner 3

The following components were mixed with a mixer, and then kneaded with a three-roll mill such that the mixture was passed through the three-roll mill twice.

| | |
|---|---|
| Pigment having formula (4) | 600 |
| Pigment having formula (5) | 200 |
| Polyol resin | 1200 |
| (number average molecular weight of 3800, Mw/Mn of 4.2, and | |
| transition temperature of 60° C.) | |

The mixture was cooled by rolling, and then pulverized with a pulverizer. Thus, a master batch pigment was prepared.

The following components were mixed, and then melted and kneaded with a two-roll mill.

| | |
|---|---|
| Polyol resin | 100 |
| (number average molecular weight Mn of 3800, Mw/Mn of 4.2 | |
| and transition temperature of 60° C.) | |
| Master batch pigment prepared above | 6 |
| Compound having formula 1-20 | 3 |
| (Charge controlling agent) | |

The kneaded mixture was cooled by rolling, and then pulverized and classified. Thus, mother particles of a magenta toner having a volume average particle diameter of 10 μm were prepared. In addition, a hydrophobic silica (H2000, manufactured by Clariant Japan.) was added thereto in an amount of 0.5% by weight, and then the mixture was mixed with a mixer to prepare a magenta toner 4. The haze factor of a thin layer of magenta toner 4 having a weight of 8 g/m² was 22%, and the melt viscosity of the toner was 89 mPas·sec at 140° C.

Cyan Toner 4

The following components were mixed with a mixer, and then kneaded with a three-roll mill such that the mixture was passed through the three-roll mill twice.

| | |
|---|---|
| Pigment having formula (3) | 800 |
| Polyol resin | 1200 |

(number average molecular weight of 3800, Mw/Mn of 4.2, and
transition temperature of 60° C.)

The mixture was cooled by rolling, and then pulverized with a pulverizer. Thus, a master batch pigment was prepared.

The following components were mixed, and then melted and kneaded with a two-roll mill.

| Polyol resin | 100 |
|---|---|
| (number average molecular weight Mn of 3800, Mw/Mn of 4.2 | |
| and transition temperature of 60° C.) | |
| Master batch pigment prepared above | 5 |
| Compound having formula 1-20 | 4 |

(Charge Controlling Agent)

The kneaded mixture was cooled by rolling, and then pulverized and classified. Thus, mother particles of a cyan toner having a volume average particle diameter of 10 μm were prepared. In addition, a hydrophobic silica (H2000, manufactured by Clariant Japan.) was added thereto in an amount of 0.5% by weight, and then the mixture was mixed with a mixer to prepare a cyan toner 4. The haze factor of a thin layer of cyan toner 4 having a weight of 8 g/m² was 19%, and the melt viscosity of the toner was 87 mPas·sec at 140° C.

### Toner Manufacturing Example 5

The procedures for preparation of the black, yellow, magenta and cyan toner in Toner Manufacturing Example 1 were repeated except that the yellow pigment was replaced with 1200 parts of an aqueous cake of Pigment Yellow 17 (solid content of 50%), and the magenta pigment was replaced with 1200 parts of an aqueous cake of Pigment Red 57 aqueous cake (solid content of 50%) to prepare a black toner 5, a yellow toner 5, a magenta toner 5 and a cyan toner 5. The haze factor of yellow toner 6 was 13%, and the melt viscosity thereof was 96 mPas·sec at 140° C. The haze factor of magenta toner 6 was 16%, and the melt viscosity thereof was 96 mPas·sec at 140° C.

### Toner Manufacturing Example 6

The procedures for preparation of the black, yellow, magenta and cyan toner in Toner Manufacturing Example 2 were repeated except that the yellow pigment was replaced with 600 parts of Pigment Yellow 17, and the magenta pigment was replaced with 600 parts of Pigment Red 122, to prepare a black toner 6, a yellow toner 6, a magenta toner 6 and a cyan toner 6. The haze factor of yellow toner 6 was 12%, and the melt viscosity thereof was 84 mpas·sec at 140° C. The haze factor of magenta toner 6 was 16%, and the melt viscosity thereof was 89 mpas·sec at 140° C.

### Carrier Manufacturing Example 1

The following components were mixed with a homomixer for 30 minutes to prepare a coating liquid for forming a coating layer on the surface of a carrier.

| | |
|---|---|
| Silicone resin solution | 100 |
| (KR50, manufactured by Shin-Etsu Chemical Co., Ltd) | |
| Carbon black | 3 |
| (BP2000, manufactured by Cabot Corp.) | |
| Toluene | 100 |

The coating liquid was coated on the surface of 1000 parts of a carrier, a spherical ferrite powder having an average particle diameter of 50 μm, using a fluidized bed type coating apparatus. Thus, a carrier A was prepared.

### Example 1

Five (5) parts of each of the color toners prepared in Toner Manufacturing Example 1 were mixed with 95 parts of carrier A to prepare four color developers.

### Example 2

Five (5) parts of each of the color toners prepared in Toner Manufacturing Example 2 were mixed with 95 parts of carrier A to prepare four color developers.

### Example 3

Five (5) parts of each of the color toners prepared in Toner Manufacturing Example 3 were mixed with 95 parts of carrier A to prepare four color developers.

### Example 4

Five (5) parts of each of the color toners prepared in Toner Manufacturing Example 4 were mixed with 95 parts of carrier A to prepare four color developers.

### Comparative Example 1

Five (5) parts of each of the color toners prepared in Toner Manufacturing Example 5 were mixed with 95 parts of carrier A to prepare four color developers.

### Comparative Example 2

Five (5) parts of each of the color toners prepared in Toner Manufacturing Example 6 were mixed with 95 parts of carrier A to prepare four color developers.

Evaluation of Toners

1. C*, a*, and b* and Area of Hexagon

A thin layer having a weight of 8 g/m² of each of the yellow, magenta and cyan toners prepared in Toner Manufacturing Example 1 was formed on an aluminum plate. Then the three toners were transferred so that a yellow, magenta, and cyan toner layer were formed on respective transfer papers. In addition, the three toners were transferred so that a red image (a double-layer of a yellow layer and a magenta layer), a blue image (a double-layer of a magenta layer and a cyan layer), and a green image (a double-layer of a cyan layer and a yellow layer) were formed on the respective transfer papers.

These images were fixed, and then the values C*, a*, and b* of the images were measured with a spectrodensitometer X-Rite 938 (manufactured by X-Rite).

In addition, the area of a hexagon formed by the six color points of the yellow, magenta, cyan, red, blue and green images plotted in a*, and b* chromaticity coordinates was measured.

Similarly, the toners prepared in Toner Manufacturing Examples 2 to 4 were also evaluated in the same method mentioned above. The results are shown in Table 1 (Examples 2 to 4).

Further, the toners prepared in Toner Manufacturing Examples 5 and 6 were also evaluated in the same method mentioned above. The results are also shown in Table 1 (Comparative Examples 1 and 2).

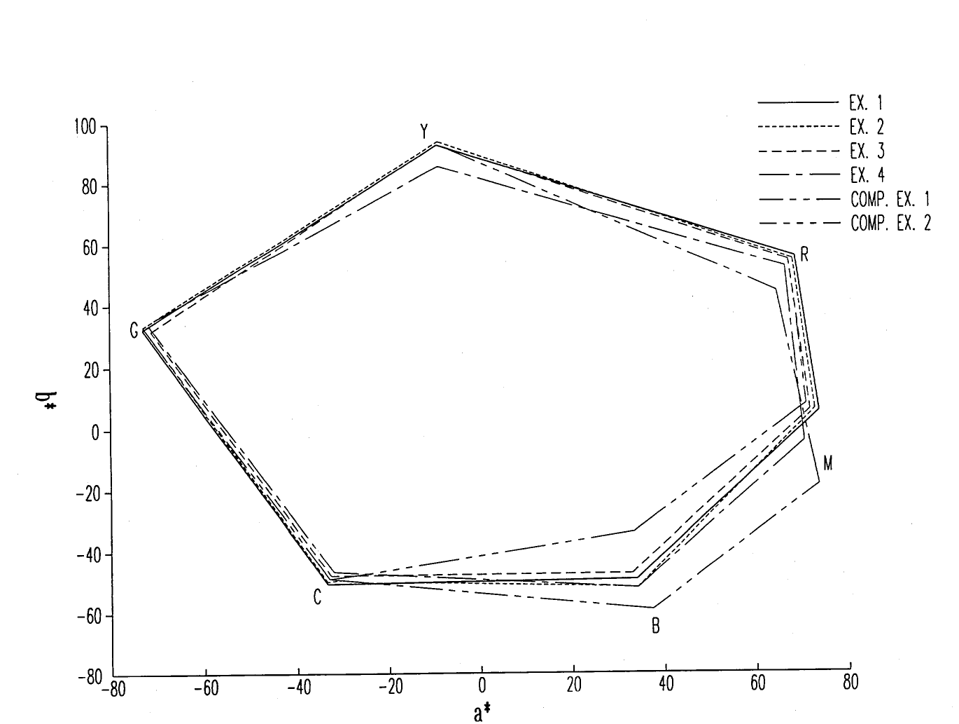

The hexagons obtained by measuring a* and b* of the color images prepared by the method mentioned below using PRETER 550 and the color developer obtained in Examples 1 to 4 and Comparative Examples 1 and 2 are shown in FIG. 1.

2. Image Quality

The developers prepared in Example 1 were installed in a color copier, PRETER 550 manufactured by Ricoh Co., Ltd., which was provided with a controller type B, and color images such as a yellow, magenta, cyan, red, blue, green, violet, and black image were formed.

In addition, the developers prepared in Examples 2 to 4 and Comparative Examples 1 and 2 were also evaluated in the same method mentioned above.

As a result, the color images prepared in Examples 1 to 4 were clear and had a good color tone. Particularly, the red images, and blue images had better image properties than those obtained in Comparative Examples 1 and 2. In the images obtained in Comparative Example 1, the red image was clear, however, the images of from blue to violet were poor. In the images obtained in Comparative Example 2, the images of from blue to violet were good, however, the red image was slightly subdued.

3. Resistance of Image to Light

The images were exposed to sunlight for 15 days (15×24 hours), and the images were visually observed to determine whether the images were faded.

As a result, the images prepared in Examples 1 to 4 were not faded. The yellow, magenta, and red image prepared in Comparative Example 1 and the yellow image prepared in Comparative Example 2 were faded. In addition, the color tone of the green and blue image prepared in Comparative Example 1 and the color tone of the green image prepared in Comparative Example 2 changed.

TABLE 1

| | | |
|---|---|---|
| a* | b* | C* |

Example 1

| | | | |
|---|---|---|---|
| Y + M | 71.2 | 56.8 | 91.1 |
| M | 76.3 | 4.0 | Area of |
| M + C | 36.1 | −50.0 | hexagon |
| C | −34.1 | −51.1 | 14776.7 |
| C + Y | −71.0 | 31.8 | |
| Y | −8.0 | 92.0 | |

Example 2

| | | | |
|---|---|---|---|
| Y + M | 69.4 | 54.2 | 88.1 |
| M | 75.0 | 3.6 | Area of |
| M + C | 36.0 | −53.0 | hexagon |
| C | −34.6 | −50.6 | 14817.7 |
| C + Y | −71.3 | 33.0 | |
| Y | −7.9 | 93.4 | |

Example 3

| | | | |
|---|---|---|---|
| Y + M | 68.1 | 54.9 | 87.5 |
| M | 73.5 | 3.9 | Area of |
| M + C | 34.8 | −48.2 | hexagon |
| C | −33.1 | −49.2 | 13815.6 |
| C + Y | −69.5 | 30.6 | |
| Y | 7.8 | 91.8 | |

Example 4

| | | | |
|---|---|---|---|
| Y + M | 67.0 | 53.1 | 85.5 |
| M | 72.4 | −3.6 | Area of |
| M + C | 35.2 | −53.2 | hexagon |
| C | −32.3 | −48.3 | 13800.8 |
| C + Y | −70.7 | 33.0 | |
| Y | −7.9 | 85.2 | |

Comparative Example 1

| | | | |
|---|---|---|---|
| Y + M | 65.8 | 45.2 | 79.8 |
| M | 75.2 | −19.2 | Area of |
| M + C | 37.9 | −59.9 | hexagon |
| C | −34.3 | −50.1 | 14884.8 |
| C + Y | −70.7 | 32.6 | |
| Y | −7.9 | 92.5 | |

Comparative Example 2

| | | | |
|---|---|---|---|
| Y + M | 70.0 | 56.0 | 89.6 |
| M | 72.0 | 6.0 | Area of |
| M + C | 35.0 | −35.0 | hexagon |
| C | −34.3 | −50.1 | 13572.1 |
| C + Y | −70.7 | 32.6 | |
| Y | −7.9 | 92.5 | |

As explained above, by preparing color toners having properties such that when a yellow toner layer and a magenta toner layer, each having a weight of 8 g/m², are overlaid, the C* value of the red image is not less than 80, and a hexagon formed by six points in a*-b* chromaticity coordinates of a fixed yellow image which is formed by a layer of the yellow toner having a weight of 8 g/m², a fixed red image which is formed by a combination of a layer of the yellow toner having a weight of 8 g/m² and a layer of the magenta toner having a weight of 8 g/m², a fixed magenta image which is formed by a layer of the magenta toner having a weight of 8 g/m², a fixed blue image which is formed by a combination of a layer of the magenta toner of 8 g/m² and a layer of the cyan toner having a weight of 8 g/m², a fixed cyan image which is formed by a layer of the cyan toner having a weight of 8 g/m², and a fixed green image which is formed by a combination of a layer of the cyan toner having a weight of 8 g/m² and a layer of the yellow toner having a weight of 8 g/m², has an area of not less than 13600, images having good image qualities such as good color tones can be produced.

In addition, by preparing a yellow toner including a benzimidazolone type pigment, a magenta toner including a Naphthol Carmine F6B or a mixture of Naphthol Carmine F6B with Naphthol Carmine FBB, and a cyan toner including β copper phthalocyanine are used in the present invention, the resultant color images have good color tone (particularly, reproducibility of red and blue images is good), and good stability (particularly good resistance to light).

Further, when the toners having a haze factor not greater than 20%, the resultant toner images have good color tones when the images are a mixed toner image.

Furthermore, when the color toners having a melt viscosity not greater than 120 mPas·sec at 140° C., the resultant toner images have further good color tones even when the images are a mixed toner image.

In addition, the toners including a specified polyol resin as a binder resin can produce images having good color tones.

Further, the toner including a specified aromatic hydroxycarboxylic acid metal salt as a charge controlling agent have good charge properties and can produce images having good image qualities such as good color reproducibility.

This document claims priority and contains subject matter related to Japanese Patent Application No. 10-315029, filed on Nov. 5, 1998, incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A color toner selected from the group consisting of a yellow toner, a magenta toner, and a cyan toner, and mixture thereof, comprising a binder resin and a color pigment;
wherein a C* value of a fixed red image formed by a combination of a layer of said yellow toner having a weight of 8 g/m² and a layer of said magenta toner having a weight of 8 g/m² is not less than 80;
and wherein a hexagon, formed by six points in a*-b * chromaticity coordinates of:
(1) a fixed yellow image formed by a layer of said yellow toner having a weight of 8 g/m²,
(2) said fixed red image,
(3) a fixed magenta image formed by a layer of said magenta toner having a weight of 8 g/m²,
(4) a fixed blue image formed by a combination of a layer of said magenta toner having a weight of 8 g/m² and a layer of said cyan toner having a weight of 8 g/m²,
(5) a fixed cyan image formed by a layer of said cyan toner having a weight of 8 g/m², and
(6) a fixed green image formed by a combination of a layer of said cyan toner having a weight of 8 g/m² and a layer of said yellow toner having a weight of 8 g/m²,
has an area of not less than 13600.

2. The color toner according to claim 1, wherein said yellow toner comprises a benzimidazolone pigment, said cyan toner comprises β copper phthalocyanine, and said magenta toner comprises at least one of either Naphthol Carmine F6B or a mixture of Naphthol Carmine F6B and Naphthol Carmine FBB.

3. The color toner according to claim 1, wherein at least one of the layers has a haze factor not greater than about 20%.

4. The color toner according to claim 1, having a melt viscosity not greater than about 120 mPas·sec at 140° C.

5. The color toner according to claim 1, wherein the binder resin comprises a polyol resin having a polyoxyalkylene chain as a main chain.

6. The color toner according to claim 5, wherein the polyol resin comprises a reaction product of: (a) an epoxy resin; (b) a dihydric phenol; and either (c) an adduct of a dihydric phenol with an alkylene oxide or (c′) a glycidyl ether of an adduct of a dihydric phenol with an alkylene oxide.

7. The color toner according to claim 1, wherein the the binder resin comprises a polyester resin.

8. The color toner according to claim 1, wherein, in said fixed red image, said combination is selected from the group consisting of (a) the yellow layer overlaid with the magenta layer, (b) the magenta layer overlaid with the yellow layer, and (c) a mixture thereof.

9. The color toner according to claim 1, wherein, in said fixed blue image, said combination is selected from the group consisting of (a) the magenta layer overlaid with the cyan layer, (b) the cyan layer overlaid with the magenta layer, and (c) a mixture thereof.

10. The color toner according to claim 1, wherein, in said fixed green image, said combination is selected from the group consisting of (a) the cyan layer overlaid with the yellow layer, (b) the yellow layer overlaid with the cyan layer, and (c) a mixture thereof.

11. The color toner according to claim 1, further comprising a charge-controlling agent.

12. The color toner according to claim 11, wherein said charge-controlling agent comprises a metal-containing aromatic hydroxycarboxylic acid derivative.

13. The color toner according to claim 12, wherein the metal-containing aromatic hydroxycarboxylic acid derivative has the following formula (1): 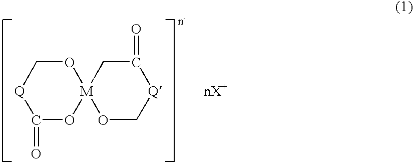
wherein Q and Q′ independently represent an aromatic oxycarboxylic acid group which may be optionally substituted with an alkyl group or an aralkyl group;
X represents a counter ion; and
M represents a metal.

14. The color toner according to claim 13, wherein said metal is selected from the group consisting of zinc, chromium, cobalt, aluminum, iron, and zirconium.

15. The color toner according to claim 13, wherein said metal is zinc.

16. The color toner according to claim 13, wherein said counter ion is hydrogen or a quaternary amine.

17. The color toner according to claim 11, wherein the charge-controlling agent is a compound having the following formula: 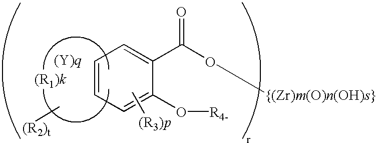
wherein R1 represents a quarternary carbon atom, a methine group, and a methylene group, and may contain a hetero atom selected from the group consisting of a nitrogen atom, a sulfur atom, an oxygen atom and a phosphor atom;
Y represents a saturated or unsaturated cyclic group;
R2 and R3 each independently is selected from the group consisting of an alkyl group, an alkenyl group, an alkoxy group, an optionally substituted aryl group, an optionally substituted aryloxy group, an optionally substituted aralkyl group, an optionally substituted aralkyloxy group, a halogen atom, a hydrogen atom, a hydroxy group, an optionally substituted amino group, a carboxyl group, a nitro group, a nitroso group, a sulfonyl group, and a cyano group;
R4 represents a hydrogen atom or an alkyl group;
k is 0 or an integer of 3 to 12;
m is an integer of 1 to 20;
n is 0 or an integer of 1 to 20;
p is 0 or an integer of 1 to 4;
q is 0 or an integer of 1 to 3;
r is an integer of 1 to 20;
s is 0 or an integer of 1 to 20; and
t is 0 or an integer of 1 to 4.

18. A color developer, comprising the color toner according to claim 1 and a carrier.

19. A method for forming a color image, comprising:
developing an electrostatic latent image with a color toner selected from the group consisting of a yellow toner, a magenta toner, and a cyan toner, and mixture thereof, to form an image;
optionally repeating said developing;
transferring the image or images onto a transfer paper to form a color image; and
fixing the color image; wherein
each of said yellow toner, said magenta toner, and said cyan toner comprises a binder resin and a color pigment; and
wherein a C* value of a fixed red image formed by a combination of a layer of said yellow toner having a weight of 8 g/m² and a layer of said magenta toner having a weight of 8 g/m² is not less than 80;
and wherein a hexagon, formed by six points in a*-b * chromaticity coordinates of:
(1) a fixed yellow image formed by a layer of said yellow toner having a weight of 8 g/m²,
(2) said fixed red image,
(3) a fixed magenta image formed by a layer of said magenta toner having a weight of 8 g/m²,
(4) a fixed blue image formed by a combination of a layer of said magenta toner having a weight of 8 g/m² and a layer of said cyan toner having a weight of 8 g/m²,
(5) a fixed cyan image formed by a layer of said cyan toner having a weight of 8 g/m², and
(6) a fixed green image formed by a combination of a layer of said cyan toner having a weight of 8 g/m² and a layer of said yellow toner having a weight of 8 g/m²,
has an area of not less than 13600.

20. A color toner selected from the group consisting of a yellow toner, a magenta toner, and a cyan toner, and mixtures thereof, each toner comprising a binder resin; wherein
said yellow toner comprises a benzimidazolone pigment, said cyan toner comprises β copper phthalocyanine, and said magenta toner comprises at least one of either Naphthol Carmine F6B or a mixture of Naphthol Carmine F6B and Naphthol Carmine FBB.

21. A method for forming a color image, comprising:
developing an electrostatic latent image with a color toner selected from the group consisting of a yellow toner, a magenta toner, and a cyan toner, and mixtures thereof, to form an image;
optionally repeating said developing;
transferring the image or images onto a transfer paper to form a color image; and
fixing the color image; wherein
each of said yellow toner, magenta toner, and cyan toner comprises a binder resin and a color pigment; and wherein
said yellow toner comprises a benzimidazolone pigment, said cyan toner comprises β copper phthalocyanine, and said magenta toner comprises at least one of either Naphthol Carmine F6B or a mixture of Naphthol Carmine F6B and Naphthol Carmine FBB.
